(19) United States
(12) Patent Application Publication
(10) Pub. No.: US 2021/0287304 A1
(43) Pub. Date: Sep. 16, 2021

(54) Dating service with restaurant selection , reservations and video promotion included

(71) Applicant: Stephone Belton, Randallstown, MD (US)

(72) Inventor: Stephone Belton, Randallstown, MD (US)

(21) Appl. No.: 16/816,296

(22) Filed: Mar. 12, 2020

(51) Int. Cl. G06Q 50/00; G06Q 10/02; G06Q 30/02; G06Q 50/02

(52) U.S. Cl. CPC G06Q 50/01; G06Q 50/02; G06Q 30/0203; G06Q 10/02

(57) ABSTRACT

This disclosure relates generally to a systematic method is disclosed for securely setting up a date in online dating applications. The first step allows a requesting member to request a date with a requested member. Next, the requesting member can enter a meeting date, place, and time. The requested member will then be prompted to either accept or decline the date request from the requesting member. The method also provides a dating history database which records a members' dating history. In addition, a method of ensuring a member's safety by allowing members to choose to have someone contacted if the member does not update the dating history database after a date is disclosed.

### BACKGROUND

### Field of the Invention

The present invention relates generally to online dating services, and more particularly, but not exclusively, to a system and method for enabling an online dating subscriber to provide another user with an online dating testimonial and/or a compliment. The invention relates to online dating services and computer applications for accessing them.

The present invention is directed toward online information systems. More specifically, the invention is directed toward functionality that can be incorporated into online dating applications to give users a sense of safety when they go out on a date with other members. The present invention further facilitates the users to meet and date at a pre-selected restaurant, chosen through the online dating application with mutual consent of both parties.

### Description of the Related Art

Online dating or Internet dating is a personal introductory system where individuals can find and contact each other over the Internet to arrange a date, usually with the objective of developing a personal, romantic, or sexual relationship. Most online dating sites allow members to upload photos or videos of themselves and browse the photos and videos of others.

Dating services are now so popular that by at least one study for the given year, over twenty-six percent of all Internet users in America have visited a personals website. Part of the reason may be that online dating may appear to be a natural extension of where people are at this point in time. That is, many people today, have personal computers, or at least access to a personal computer. Moreover, virtually everyone wants to fall in love. Thus, it is natural to merge these two things. As such, online dating services may appear as the world's biggest singles bar. Except that it can be done in the privacy of one's own home where time may be taken to read about another person and get to know them through email, phone, and the like, before ever going on an actual date.

Users of social networking services may form connections, associations, or other relationships with other users based on real-life interactions, online interactions, or a wide variety of other bases. For example, users may choose to connect with others who are in the same geographic location, who have a common circle of friends, who have attended the same college or university. etc. Existing social networking systems provide limited mechanisms for finding such connections.

In some instances, for example, social networking systems provide individuals with access to an introduction mechanism. The introduction mechanism may be as simple as showing the profiles of matched individuals through listings, social network visualizations, or through context-aware match alerts and introduction management tools that aim to encourage interpersonal contact. Without doing a specific search for a user, it is a common challenge for users to locate other users with whom they may wish to form a connection. Identifying users for specific types of connections is almost impossible. As such, needs exist for improved techniques for identifying and connecting users. Thus, there has been a flurry of companies launching services that help people to meet and develop a personal relationship. Many of these companies, however, are struggling with developing additional services that will build customer loyalty. Without the ability to extend the value of the online dating experience, online dating may lose its appeal. Therefore, it is with respect to these considerations and others that the present invention has been made

Online dating services usually provide immoderate matchmaking over the Internet, through the use of personal computers or cell phones. Users of an online dating services usually provide personal information, which enable them to search the service provider's database for other individuals. Members use criteria requested by the particular online dating platform, such as age range, gender and location.

Some online dating sites may offer additional services, such as webcasts, online chat, telephone chat (VOIP), and message boards. Some sites provide free registration, but may offer services which require a monthly fee. Other sites depend on advertising for their revenue. Some sites such as OkCupid.com, POF.com, and Badoo.com are free and offer additional paid services in a premium revenue model.

Online dating sites and applications facilitate match making and choosing partners for meeting and dating. The process of search, messaging, sharing of profiles and videos and exchanging the time and place for meeting is empowered through computer and software system. Currently, limited or no specific dating application facilitates the users to choose restaurants from the dating site and finalize their date at a safe place with mutual consent. In the same context, very less or limited dating sites have direct liaison and contracts with restaurants and eating places and further offering discounts for visiting. The current application has this novel feature of facilitation to date at a safe place which can be chosen by the user at their convenience and mutual consent.

It may therefore be desirable to provide improved systems and methods for performing cryptographic operations and for verifying the solutions generated from the cryptographic operations. With all previous embodiments in the field did not provide such facilitation and hence the idea has its own novelty.

### SUMMARY

The present invention provides a method to search possible match for dating through online dating website/application and setting up the date at a selected restaurant facilitated through the dating site. The ‘set up date’ functionality allows the user to set a meeting time, date and location.

In one embodiment, a method for profile matching comprises receiving a plurality of user profiles, each user profile comprising traits of a respective user. It also comprises receiving a preference indication for a first user profile of the plurality of user profiles. It further comprises determining a potential match user profile of the plurality of user profiles based on the preference indication for the first user profile. The method also comprises presenting the potential match user profile to a second user.

Receiving a preference indication for a first user profile may include receiving from a third user a recommendation of the first user profile for the second user. It may also include receiving from the second user a preference indication for the first user profile. The method may further include determining a score of a third user profile of the plurality of user profiles as a potential match for the second user. It may also include altering the score of the third user profile based on the preference indication for the first user profile.

In another embodiment, a method for profile matching comprises receiving a plurality of user profiles, each user profile comprising traits of a respective user. The method further comprises receiving a request for matches from a first user, the first user associated with a first user profile. The method also comprises scoring the plurality of user profiles for potential matching with the first user based on comparisons of the plurality of user profiles with the first user profile. It also comprises identifying a second user profile of the plurality of user profiles as a potential match for the first user based on the scoring and confirmation of their profiles.

It is accordingly an object of the invention to provide a dedicated computer client application for searching an online dating database that overcomes the above-mentioned disadvantages of the heretofore-known devices and methods of this general type and that consumes a minimum of computer and desktop resources and that allows a user to passively browse profiles of potential matches while continuing to work using other applications on the computer desktop.

The search page provides a means for entering criteria with which the database can be searched for potential matches. A search page is provided within the window of the application. The search page allows criteria matching fields in the database to be entered. Once the user enters data in the application, the criteria are submitted to the web server and online database; potential matches are found and transmitted to the application where they are displayed.

Although the invention is illustrated and described herein as embodied in a dedicated computer client application for searching an online dating database, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

It is a further object of the present invention to provide a process to keep records of dating activities. A dating history database has the functionality to keep records of requested dates, accepted dates, dates declined, time and location of dates attended, user name of requester, real name of requester, and the like.

It is a further object of the present invention to provide a sense of safety for members of online dating communities who wish to meet other users in person. The functionality of the current invention will allow users to select the meeting place and time through the application. The selection would update the dating history database and the relevant restaurant would also get the information as at selected places promo codes and coupons are also issued to users for dating.

Other objects, features and advantages of the present invention will be apparent from the accompanying drawing and from the detailed description which follows.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards enhancing an online dating experience by enabling a subscriber to the service to provide an online dating testimonial from a friend, family member, companion, and the like, to another subscriber. The invention further enables the subscriber to tell a date how they may feel about the date in a non-email format. In one embodiment, the subscriber may select from a list of predefined messages. The subscriber may also modify the predefined message before sending to the date.

The invention, however, is not constrained to use by subscribers or registered users. As such a non-subscriber may be permitted to provide testimonials. By enabling the non-subscriber to provide testimonials, an increased amount of feedback may be obtained about a subscriber. Moreover, by enabling such testimonial feedback, the non-subscriber may be encouraged to become a subscriber of the service.

The invention is based on components of an exemplary environment in which the invention may be practiced. Not all the components may be required to practice the invention, and variations in the arrangement and type of the components may be made without departing from the spirit or scope of the invention.

The invention, which is a dating site can be viewed and used from a personal computer, laptop, PDA or any computing device. To have connectivity with other members and for real time utility needs to be connected to internet through local area networks (“LANs”)/wide area networks (“WANs”), wireless network or independent internet source. Further, the internet would connect the user to the, online dating server (ODS), client device and mobile device, where applicable.

Generally, client device may include virtually any computing device capable of receiving and sending a message over a network, such as LAN/WAN or independent network, wireless network, and the like, to and from another computing device, such as server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, Tablets or PDAs. Similarly, client device may be any device that is capable of connecting using a wired or wireless communication medium such as a PDA, POCKET PC, wearable computer, and any other device that is equipped to communicate over a wired and/or wireless communication medium.

Client device may include a browser application that is configured to receive and to send web pages, web-based messages, and the like. The browser application may be configured to receive and display graphics, text, multimedia, and the like, employing virtually any web based language, including Standard Generalized Markup Language (SMGL), HyperText Markup Language (HTML), and so forth.

Client device may further include a client application that enables it to perform a variety of other actions, including, communicating a message, uploading a video, giving its location and establishing links for payments and communication between itself and another computing device. The browser application, and/or another application, such as the client application, a plug-in application, and the like, may enable client device to communicate content to another computing device.

Mobile device represents one embodiment of a client device (users on both ends) that is configured to be portable. Thus, mobile device may include virtually any portable computing device capable of connecting to another computing device and receiving information. Such devices include portable devices such as, cellular telephones, smart phones, Personal Digital Assistants (PDAs), handheld computers, wearable computers, tablet computers, integrated devices combining one or more of the preceding devices, and the like.

Mobile computing device also may include at least one client application that is configured to receive content from another computing device. The client application may include a capability to provide and receive textual content, graphical content, audio content, and the like. The client application may further provide information that identifies itself, including a type, capability, name, identifier, and the like. The information may also indicate a content format that mobile device is enabled to employ.

Client computing device and mobile device may be further configured by use of browser to enable a user to participate in an online dating service, manage personal user information associated with the online dating service. Client/User application may enable a user to interact with the browser application, email application, and the like, to manage their online dating information.

The users may employ the client application, in part, to create a user profile, participate in an online dating analysis, and the like. The client application may then enable the user to attach the online dating testimonial to an online dating user profile, and the like. For example, the user may attach the online dating testimonial to a link that a reader of the user's profile may select for reading recommendations, and similar comments. The user may also attach the online dating testimonial to a graphic, such as a self-photo, such that when the photo is selected the online dating testimonial may also be displayed.

The client application may further enable the user to receive and interact with results of a search that is based, at least in part, on the user's input to the online dating service. Moreover, the client application further enables the user to provide online dating feedback to the online dating service regarding a date, a correspondence with a potential date, and so forth.

With respect to the process and flow chart of the online dating application the first step of the method of setting up a date for an online dating application is to get registered. When users register to become members of online dating communities, they are prompted to enter a great deal of personal information. The relevant information that will be needed for the ‘set up a date’ methodology is their real name and user name. A user's real name is their first and last name. When a member requests a date, the requested member will see the user's real name. This will reduce the likelihood that a member would contact another member for a date with fraudulent or inappropriate intentions. The reason for this is that they are being tracked by their real name and would be reluctant to commit any wrongdoing under the risk of being caught easily. The first step in the ‘set up a date’ process also involves the user to enter a username. This will be the name that members will see when searching for other members.

The second step of the method of setting up a date for through the online dating application. Once a member has registered, they can browse the online dating application to view other members. These members will be labeled under their usernames. When the user finds a member he/she is interested in, he/she may contact the member. Once the two members communicate, one member may choose to request a date. While the members may do so in a traditional manner via telephone call or email, the ‘set up a date’ process herein described offers a safe alternative that will allow members to request and accept dates while maintaining a sense of security regarding their personal safety. The safety process is enabled by selection of listed restaurants in the state and outside state. Reservation can be made through the site where further discount coupons can be purchased as well.

When a member wishes to set up a date with another member, he/she will click on the “request a date” button on that member's page. The requesting member will then be prompted to enter the information including their username, their real name, a meeting time and a meeting place. The username and real name must match with the information entered during the registration. This will prevent a person from requesting a date under another member's username or real name. The meeting date must be a specific day in the future. For example, a date can be requested for “February 17^{th}”, but not for “Next Week” or “the Day after Tomorrow”. In addition, the time has to be specific and cannot be a general time period. This is further powered by selection of meeting place which varies from hotels, restaurants, bars or any other eating and meeting public place listed in the site. For example, an acceptable time would be 8:30 PM and not simply “In the Evening”. Further, the meeting place must show a specific address. This will help reassure the requested member that others will know exactly where the date will take place. An example of an acceptable meeting place would be “The Wine Bar at 112 N. Broad St., Philadelphia Pa. 19370.” To facilitate this process, drop down menus may be provided to input the day and time of the date at the selected location chosen by mutual consent of both users. Additionally, an alternative embodiment of the process may also require that the address be verified as a real address from a reliable database. Once the requesting user has input all of the above information, the user may next submit his/her date request.

The next step of the method of setting up a date for an online dating application is shown. When a requested member receives a date request, they will see the “request message” button flashing on their page. This will alert the member that someone has sent a message. When the requested member clicks on the button, the member will be given the choice to either accept the date or decline the date. The requested member can accept or decline by hitting either the “Accept Date” button or “Decline Date” button. This will then send a response back to the requesting member. The requesting member will then see the “request status” button flashing on their page. This will alert the requesting member that they have received a response from their date request.

Another step of the method of setting up a date for an online dating application is shown. All members will have their dating history record updated when the member makes date requests, receives responses from their date requests, accepts dates or declines dates. The dating history record will also be updated when a member indicates that he/she has returned safely from the date if they choose to have the emergency contact measure, which is described in FIG. 5. When a member makes a date request, a record will be kept showing when the request was made, to whom it was made, when it was made, the details of the request, and whether the date was accepted or denied. When a member receives a date request, the dating history record will be updated to show who the request was from, the details of the request, and whether the request was accepted or declined. All of the above referenced information will be automatically input in to the dating history record when requests are made, accepted, or declined. As such, members will not be able to edit their own dating history record. Members will also not be able to view the dating history records of other members.

The invention has another step as per the flow diagram of the method of setting up a date for an online dating application is shown. To provide another level of security and further ensure that members have peace of mind when using the set up a date methodology, members may choose to meet at a place of their own choice. They can choose the place from the drop down menu and select the place. Further, the time and date would be confirmed by the users. In addition, another tab offers the incentive to purchase discount coupon for the selected place. This would be applicable on the edibles and other related activities at that very vicinity. On confirmation notification may be made by an automated message or by a phone call from an administrator.

It is appreciated that additional advantages, modifications and equivalent embodiments will be apparent to those skilled in the art. Therefore, the invention, in its broader aspects, is not limited to the specific details shown and described herein. Accordingly, various modifications may be made without departing from the spirit or scope of this invention as defined by the appended claims and their equivalents.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

### BRIEF DESCRIPTION OF DRAWING

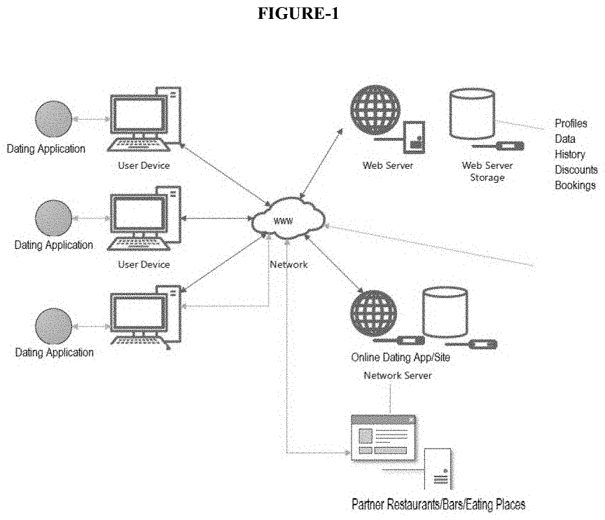

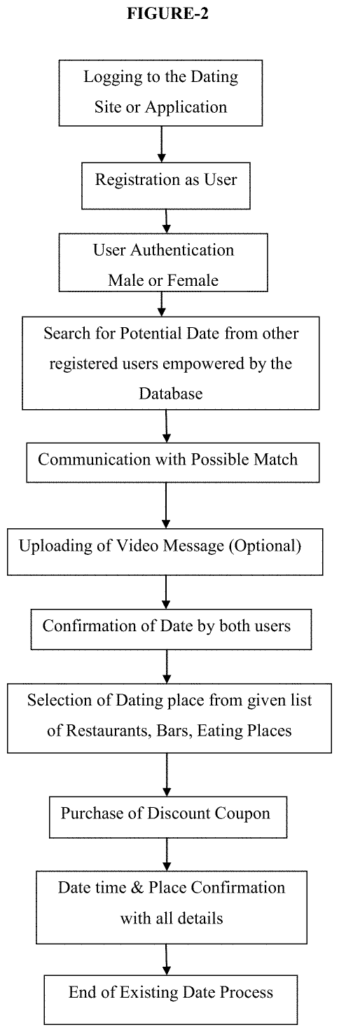

Non-limiting and non-exhaustive embodiments of the present invention are described with reference to the following drawings. The system and method of the present invention will now be described with reference to the accompanying flow chart drawing figure, in which: FIG. 1 shows a functional block diagram illustrating one embodiment of the online & IT based environment for use and practice of the invention with server device that may be included in a system implementing the invention; and FIG. 2 illustrates a logical flow diagram generally showing one embodiment of a process of registration, find the match, communication, selection of site for date & optional purchase of discount coupon, in accordance with the present invention.

1. A method for use in managing an online dating message, comprising:
a. selecting a recipient from an online dating site;
b. selecting at least one predefined online dating feedback message from a set of predefined online dating feedback messages;
c. if an online dating testimonial is received, providing access to the online dating testimonial within the online dating environment,
d. selecting at least one predefined dating place/restaurant from a set of restaurants listed on the site;
e. Purchase of discount coupon for selected restaurants from the site.

2. The method of claim 1, wherein selecting the recipient further comprises selecting the recipient from at least one of an online dating candidate, date and place.

3. The method of claim 2, wherein the online dating candidate further comprises a candidate selected from a list of online dating candidates obtainable, in part, by performing an online dating search.

4. The method of claim 1, wherein the set of predefined online dating feedback messages further comprises at least one message for indicating a desire for a date, indicating a desire for another date, indicating that no further contact is desired, indicating that prior form of contact was enjoyable, indicating a compliment, providing dating or relationship help or advice, and indicating that prior form of contact was not enjoyable.

5. The method of claim 1, wherein the method is configured to operate with a mobile device.

6. The method of claim 1, further comprising:
a. composing another online dating feedback message; and
b. sending the composed online dating feedback message to at least one other recipient within the online dating environment.

7. A server that is configured for use in managing an online dating message, comprising a transceiver for receiving and sending information to another computing device.
